(19) United States
(12) Patent Application Publication
(10) Pub. No.: US 2004/0028839 A1
(43) Pub. Date: Feb. 12, 2004

(54) Optical anisotropic film

(76) Inventors: Michael V. Paukshto, Foster City, CA (US); Pavel I. Lazarev, Belmont, CA (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/349,759

(22) Filed: Jan. 22, 2003

Related U.S. Application Data
(60) Provisional application No. 60/401,993, filed on Aug. 7, 2002.

(51) Int. Cl. C09K 19/00

(52) U.S. Cl. 428/1.1

(57) ABSTRACT

There is disclosed an optical anisotropic film which includes at least one anisotropic crystalline layer comprising a substance whose molecules contain aromatic rings and form a lattice and at least one transparent layer. The relative refractive index n satisfies the condition 2n²<nₒ²+ne² where nₒ and nₑ, are the refractive indices of the crystalline layer for ordinary and extraordinary rays respectively.

### RELATED APPLICATIONS

This application claims priority to U.S. Provisional Application No. 60/401,993, filed on Aug. 7, 2002.

### FIELD OF INVENTION

This invention pertains to optical anisotropic films. The invention can be used as optical element in liquid crystal display (LCD) devices, particularly as polarizing or phase-shifting layers in LCDs of both reflection and transmission type, and in any other field of science and technology where optical anisotropic films are applied, e.g., in architecture, automobile industry, decoration arts, etc.

### BACKGROUND ART

There is a known polarizing film [M. M. Zwick, J. Appl. Polym. Sci., 9, 2393-2424 (1965)], representing a base polymer film oriented by uniaxial stretching and bulk-stained with iodine compounds. The base polymer is mostly poly(vinyl alcohol) (PVA) or some of its derivatives. The iodine-stained PVA polarizers exhibit high polarization characteristics in a long-wave length part of the visible spectral range and find application in LCD production.

Disadvantages of the iodine-containing polarizers are low moisture resistance and low thermal stability, leading to a short working life under conditions of high humidity and elevated temperatures. The application of protective films does not significantly increase the working life of these polymer films. Besides, providing an additional layer increases the total polarizer thickness, reducing the polarizer performance, and complicates the production process, increasing the cost of production.

Another drawback of the iodine-stained PVA polarizers is the restricted working spectral range, they are primarily effective in a long-wave part of the visible spectral range, these polarizers cannot provide for a sufficiently high optical dichroism in the shortwave part of this spectral range.

The iodine-stained PVA polarizers transmit the ordinary light ray and, hence, belong to polarizers of the O-type. This property is due to certain features of the fabrication process. Uniaxial stretching of a bulk-stained polymer film leads to orientation of the anisometric iodine molecules, which align with their long axes in the stretching direction, thus providing for the optical anisotropy, optical dichroism, and polarizing properties of the film. The extraordinary light wave, which is polarized parallel to the axis of preferential orientation of iodine molecules, is absorbed by the film, while the ordinary wave polarized perpendicularly to the orientation direction is transmitted. A significant disadvantage of the O-type polarizers is the sharp drop in the contrast with increasing viewing angle. Another drawback consist in rather high leakage of light which passes through a pair of crossed polarizers of the O-type, these losses also increasing with the viewing angle [Y. Bobrov, A. Grodsky, L. Ignatov, A. Krivostchepov, V. Nazarov, and S. Remizov, Thin Film Polarizers for Liquid Crystal Displays, SPIE (2001)]. This factor significant decreases the polarization efficiency.

There are known polarizers containing dichroic dyes (see, for example, U.S. Pat. No. 5,340,504 and JP59145255), which are fabricated similarly to the iodine-containing films described above. The polarizing film is obtained by uniaxial stretching of a polymer (PVA) film bulk-stained with a dichroic dye. The polarizers containing dichroic dyes are more stable with respect to the ambient factors as compared to the iodine-stained polarizers, that is, the former possess a higher moisture resistance and thermal stability.

Disadvantage of the polarizers containing dichroic dyes is a significant inhomogeneity of the optical dichroism of such polarizers in the visible spectral range. These polarizers are least effective in a short-wave spectral region.

In the production of TN and STN LCDs, there is a need for polarizers with the optical axis lying in the plane of the polarizing film at a certain angle relative to the polarizer edge. Such devices are obtained by uniaxially stretching a stained polymer film with the standard direction of optical axis (parallel to the film edge), followed by cutting a polarizer with desired orientation of the optical axis relative to the polarizer edge. The cutting wastes amount up to 20% of the initial film material, which increases the cost of production.

Produced by a process analogous to that used for the fabrication of iodine-stained polarizers, the polarizers stained with dichroic dyes also belong to polarizers of the O-type and, hence, possess the same disadvantages: low contrast and high leakage of light as it passes through a pair of crossed polarizers of the O-type, at the oblique viewing angle.

There is a known dichroic polarizer [PCT Publ. WO 94/28073, 1994] representing a film containing at least one dichroic organic compound, the molecules (or molecular fragments) of which possess a planar configuration. The content of the dichroic compound in the film is not less than 70%. The molecules form orientationally ordered ensembles, in which the planes of molecules (and the dipole moments of optical transitions occurring in these planes) are oriented perpendicularly or almost perpendicularly to the macroscopic orientation axis of the polarizing film.

The process of polarizer fabrication includes application of a liquid-crystalline organic dye solution, its alignment, and drying at 20-80° C.

The dichroic polarizer exhibits a high thermal stability, resistance to radiation damage, and high polarization characteristics.

Disadvantages of this dichroic polarizer are related to the presence of thin filamentary aggregates in the polarizing film. Orientations of the dipole moments of molecules entering into various aggregates are rather weakly correlated. The absence of a high degree of orientation of the organic dye molecules does not allow the optical characteristics of the polarizer to be significantly increased. In addition, the presence of filamentary aggregates hinders the obtaining of films possessing sufficiently homogeneous distribution of anisotropy over the film surface.

There is a known dichroic polarizer [PCT WO 00/25155, 2000], which is the most close analog of the disclosed invention and represents a film containing at least one dichroic organic compound, the molecules or molecular fragments of which possess a planar configuration. At least a part of this film possesses a crystalline structure, representing a three-dimensional crystal lattice formed by the molecules of at least one dichroic compound.

Methods used for the obtaining of such thin, ordered, partly crystal films include application of a film of an organic dichroic substance onto a substrate and orientation of the film using any of the well-known methods. Optimum conditions for the fabrication of such polarizers are offered by applying a solution of a liquid-crystalline dichroic substance onto a substrate with simultaneous mechanical orienting action upon the film, followed by evaporation of the solvent. Mechanical alignment of the solution of the liquid-crystalline dichroic substance results in ordering of the linear molecular aggregates, representing structural units of such solutions, relative to the direction of application of the mechanical factor, whereby the molecules are oriented perpendicularly to this direction. This ordering facilitates the incorporation of molecules of the organic substance into the crystalline lattice formed in the course of solvent evaporation from the liquid-crystalline solution. Under the optimum conditions, a crystalline structure may form over the entire film, which ensured a high polarizing efficiency of the polarizer. A typical thickness of such polarizers is about 1 micron, which increases the working characteristics as compared to those of the polarizers described above, in particular, allows the LCD to be viewed at greater angles.

The optical anisotropy of a film is characterized by the order parameter S determined by the formula S=(D_{⊥}−D_{∥})/(D_{⊥}+2D_{∥}), where D, D_{⊥} and D_{∥}, is the optical density (absorbance) measured in a polarized light, with the polarizer axis perpendicular and parallel to the plane of polarization of the electromagnetic radiation. In fabricating dichroic polarizers, the film formation conditions and the type and magnitude of the orienting action are selected so as to provide that the order parameter, corresponding to at least one absorption peak in the spectral range from 0.7 to 13 μm, would be not less than 0.8.

The order parameter describes macroscopic properties of the obtained polarizing film. The absence of data on the microscopic characteristics of the film, hindering control of the crystallization process and the optical properties of the film during fabrication, is a significant disadvantage of this technology. In addition, the absence of data on the parameters of crystallization leads to inhomogeneity of the degree of crystallization over the film surface, which results in poor reproducibility of the optical properties of anisotropic films.

### SUMMARY OF THE INVENTION

It is the object of the present invention to provide an optical polarizing film having a high contrast and high polarization efficiency in a broad spectral range.

Technical results of the disclosed invention are as follows:

high anisotropy and large degree of crystallinity of the polarizing films;

increased contrast and polarization efficiency of the films;

high homogeneity of the films with respect to the degree of crystallization and good reproducibility of the optical properties of anisotropic films in the course of fabrication;

reduced cost of the obtained polarizers.

Additional positive technical results are as follows:

increased moisture resistance and thermal stability of the polarizing films;

the possibility of using the films for protecting LCDs against UV radiation;

the possibility of using the films as polarizers and phase-shifting layers.

There is disclosed an optical anisotropic film which includes at least one anisotropic crystalline layer comprising a substance whose molecules contain aromatic rings and form a lattice and at least one transparent layer. The relative refractive index n satisfies the condition 2n²<nₒ²+ne² where nₒ and nₑ, are the refractive indices of the crystalline layer for ordinary and extraordinary rays respectively.

### BRIEF DESCRIPTION OF THE DRAWINGS

The disclosed invention will be more clearly understood from the following description when read in conjunction with the accompanying drawings in which

FIG. 1 is a sectional view of and optical anisotropic film comprising a crystal film on a substrate, along with adhesive and protective layers.

FIG. 2 is a sectional view of the optical anisotropic film that includes an anti-reflective layer.

FIG. 3 is a sectional view of the optical anisotropic film that includes a reflective layer.

FIG. 4 is a sectional view of the optical anisotropic film that includes a diffusive or specular reflector as a substrate.

### DETAILED DESCRIPTION OF PREFERRED EMBODIMENTS

The invention will be more clearly understood from the following examples.

### EXAMPLE 1

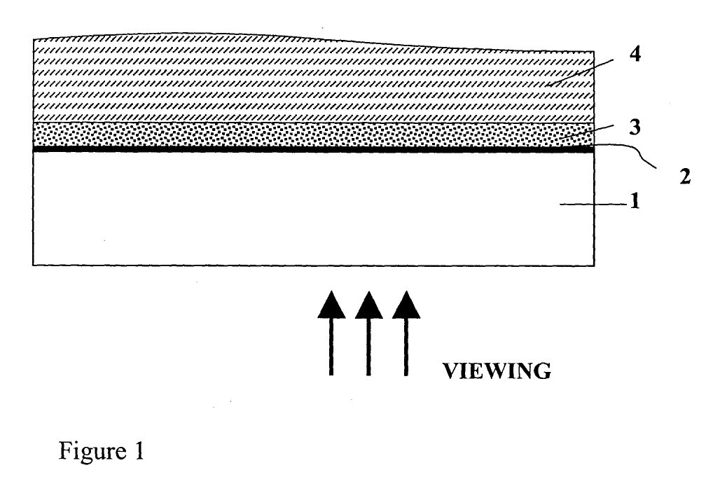

Referring to FIG. 1, an optical anisotropic film is formed on substrate 1. The film contains anisotropic crystal layer 2, adhesive layer 3, and protective layer 4.

Substrate 1 is made of polyehtylene terephthalate (PET) (e.g., Toray QT34/QT10/QT40, or Hostaphan 4607, or Dupont Teijin Film MT582). The substrate thickness is 30 to 120 μm; the refractive index is n=1.5 (Toray QT10), 1.7 (Hostaphan 4607), 1.51 (Dupont Teijin Film MT582).

The anisotropic crystalline layer 2, TCF N_{—}015.05.110 (Optiva, Inc.), is between 100-400 nm thick with refractive indices nₒ=1.5 and nₑ=2.1 for the ordinary and extraordinary rays, respectively; it has a dichroic ratio of Kdₘ=kₒ/kₑ=18.4 (up to 30); a transmission of T=48%; a contrast ratio CR=5-6; and a polarization efficiency of Eₚ=85%.

The polymer layer 4 protects the optical anisotropic layer from damage in the course of transportation of the optical anisotropic film.

This optical anisotropic film is a semi-product, which can be used as an external polarizer in for example, LCDs. Upon removal of the protective layer 4, the remaining film is applied onto the LCD glass with adhesive layer 3. An important advantage of this optical anisotropic film in reflective LCDs is a significant decrease in the fraction of light reflected from the LCD front surface. This is achieved by matching the refractive indices of substrate and crystal film so as to obey the condition 2n²<n₀²+nₑ², where nₒ and nₑ are the refractive indices of the crystal film for the ordinary and extraordinary rays, respectively.

### EXAMPLE 2

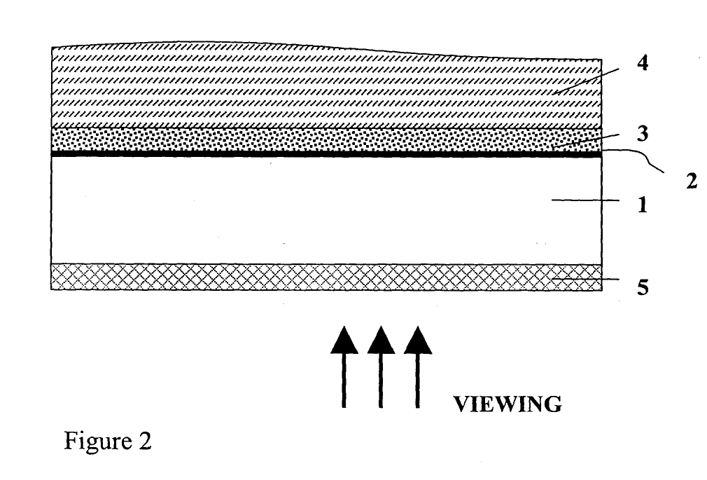

The above described optical anisotropic film is applied to the LCD front surface with an additional antireflection layer 5 formed on the substrate (FIG. 2). For example, an antireflection layer of silicon dioxide SiO₂ reduces by 30% the fraction of light reflected from the front surface.

### EXAMPLE 3

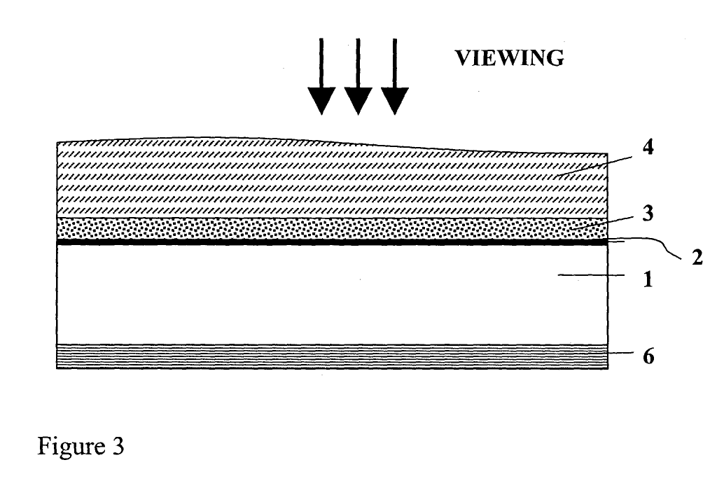

With the above described optical anisotropic film applied to the LCD front surface, an additional reflective layer 6 can be formed on the substrate (FIG. 3). The reflective layer can be obtained, for example, by depositing an aluminum film. The film can then be used in a reflective LCD.

### EXAMPLE 4

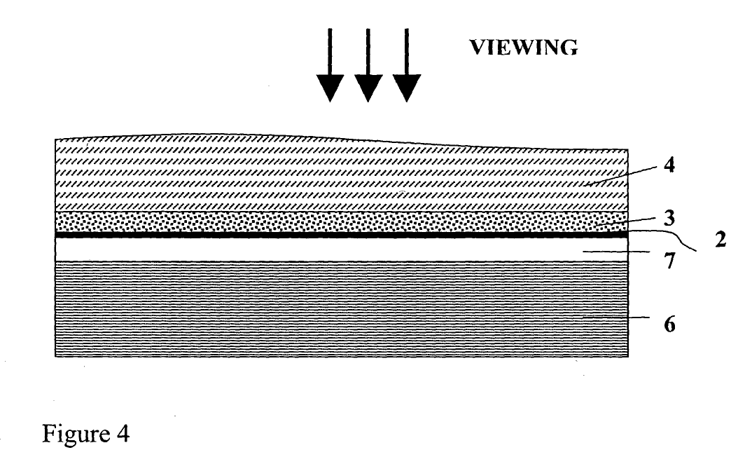

The anisotropic thin crystal layer 2 is applied to the diffusive or specular reflector 6 which serves as a substrate (FIG. 4). The reflector layer 6 could be covered with the planarization layer 7 (optional). For the planarization layer it could be used polyurethane or acrylic or any other planarized layer.

The anisotropic crystalline layer 2, representing TCF N 015.05.110 (Optiva, Inc.), is between 100-400 nm thick and has the refractive indices nₒ=1.5 and nₑ=2.1 for the ordinary and extraordinary rays, respectively; a dichroic ratio of Kdₘ=kₒ/kₑ=18.4 (up to 30); a transmission of T=48%; a contrast ratio CR=5-6; and a polarization efficiency of Eₚ=85%.

The adhesive layer 3 and the protective layer 4 are applied on the top of the anisotropic crystalline film.

An important advantage of this optical anisotropic film in reflective LCDs is a significant decrease in the fraction of light reflected from the LCD front surface. This is achieved by matching the refractive indices of the adhesive film 3 and crystalline film 2 so as to obey the condition 2n²<n₀²+nₑ², where nₒ and nₑ are the refractive indices of the crystal film for the ordinary and extraordinary rays, respectively.

### EXAMPLE 5

In case of the transflective design of the optical anisotropic film, the reflector layer 6 semitransparent. The anisotropic thin crystal layer 2 is applied to the diffusive or specular semitransparent reflector 6 which serves as a substrate (FIG. 4). The reflector layer 6 could be covered with the planarization layer 7 (optional). Polyurethane or acrylic or any other planarized layer can be used for this planarization layer.

The substrate 6 is of PET (e.g., Toray QT34/QT10/QT40, or Hostaphan 4607, or Dupont Teijin Film MT582). The substrate thickness is 30 to 120 μm; the refractive index is n=1.5 (Toray QT10), 1.7 (Hostaphan 4607), 1.51 (Dupont Teijin Film MT582). The anisotropic crystalline layer 2, representing TCF N 015.05.110, is between 100-400 nm thick and has the refractive indices nₒ=1.5 and nₑ=2.1 for the ordinary and extraordinary rays, respectively; a dichroic ratio of Kdₘ=kₒ/kₑ=18.4 (up to 30); a transmission of T=48%; a contrast ratio CR=5-6; and a polarization efficiency of Fₚ=85%.

An adhesive layer 3 and the protective layer 4 are applied on the top of the anisotropic crystalline layer.

The refractive indices of both the substrate and the adhesive layer are matching the refractive indices of the crystalline film 2 so as to obey the condition 2n²<n₀²+nₑ², where nₒ and nₑ are the refractive indices of the crystal film for the ordinary and extraordinary rays, respectively.

The optical anisotropic film contains at least one anisotropic crystalline layer formed on a substrate which is optically transparent in one embodiment; and it is formed on a reflector (with or without an additional planarization layer) with an optically transparent adhesive in another embodiment. The first presented embodiment is designed for the transmissive displays, and the aforesaid second embodiment is designed for the reflective displays. The disclosed optical anisotropic film could be also designed for the transflective displays. In this case both adhesive layer and substrate should be of an optical anisotropic properties. This crystalline layer represents a substance whose molecules contain aromatic rings and form a lattice with an interplanar spacing of 3.4±0.3 Å along one of the optical axes. The substrate material and/or the adhesive material are selected so that each refractive index n would satisfy the conditions 2n²<n₀²+nₑ², where nₒ and nₑ are the refractive indices of the crystal film for the ordinary and extraordinary rays, respectively.

The adhesive layer could be isotropic or anisotropic.

The substrate surface facing the crystal film layer can be hydrophilic and the surface may possess a relief and/or texture producing orienting action upon the near-surface layer of the crystal film. Alternatively, the optical anisotropic film may include an additional interlayer, formed between the substrate and the crystalline layer, possessing the aforementioned properties.

In some cases, there is an antireflection or antiflashing coating between the crystal film and the adhesive and/or the substrate.

In some cases, the substrate is covered with a semi-transparent coating.

The substance of the crystal film layer may contain heterocycles.

A material for the crystal film layer may include at least one organic substance, the chemical formula of which contains (i) at least one ionogenic group ensuring solubility in polar solvents for obtaining a lyotropic liquid-crystalline phase, (ii) at least one counterion, which is either retained or not in the molecular structure in the course of the crystal film formation, and/or (iii) at least one nonionogenic group ensuring solubility in nonpolar solvents for obtaining a lyotropic liquid-crystalline phase.

In order to prevent the damage of optical anisotropic films during transportation, it is recommended that the polarizers would be covered by a removable protective film.

The optical anisotropic film may include an additional adhesive layer formed between the crystalline and protective layers, whereby the binding between the protective and adhesive layer is smaller than that between the crystalline and adhesive layers, so that the adhesive layer would be retained on the crystalline layer upon removal of the protective layer.

The substrate and/or the adhesive layer can be made of a material absorbing UV radiation. Alternatively, the anisotropic film may contain an additional layer made of a material absorbing UV radiation.

As a rule, the crystalline layer represents a polarizer of the E-type [P. Yeh and C. Gu, Optics of Liquid Crystal Displays, Wiley, New York (1999); P. Yeh and M. Paukshto, Molecular Crystalline Thin Film E-Polarizer, Mol. Mater., 14(1) (2000)], with the components of imaginary (K₁, K₂, K₃) and real (n₁, n₂, n₃) parts of the complex refractive index of the crystalline layer obeying the relations K₁≧K₂>K₃ and (n₁+n₂)/2>n₃. The crystal film may simultaneously perform the functions of a polarizer and a phase-shifting layer [P. Lazarev and M. Paukshto, Thin Crystal Film Retarders, IDW-2000 Conference Proceedings, October 2000.].

A substrate for the optical anisotropic film can be made of either glass of a transparent polymer, for example, polyehtylene terephthalate (PET), polycarbonate, and cellulose acetate. The substrate transmission coefficient must be not lower than 80%, preferably not lower than 90%. The substrate can be also optically anisotropic. In addition, the substrate must protect the crystal film from mechanical damage, this requirement determining the substrate thickness and strength.

In case the optical anisotropic film is designed for the reflective displays, the substrate could be made as a reflector. It could be made of diffusive or specular reflective material, or the substrate with a reflecting coating. In addition to the reflective coating, the substrate that is in contact with a crystalline film could be either covered with a planarization layer or the surface of a reflector layer itself is planarized.

The technical results of the disclosed invention are achieved by using at least one crystal film characterized by small thickness, low temperature sensitivity, high anisotropy of the refractive index, anisotropy of the absorption coefficient, high dichroic ratio, and simplicity of fabrication. These properties are determined by the method of film synthesis and features of the film material, namely, by the molecular-crystalline structure representing a layer of at least one molecularly oriented organic substance capable of forming a colloidal system (stable lyotropic liquid-crystalline phase). Dissolved in an appropriate solvent, such an organic compound yields a colloidal system (lyotropic liquid crystal) in which molecules are aggregated into supramolecular complexes constituting kinetic units of the system. This liquid crystal is essentially a pre-ordered state of the system, from which the anisotropic crystal film is formed in the course of orientation of the supramolecular complexes and removal of the solvent.

A method stipulated for the synthesis of crystal films from a colloidal system with supramolecular complexes includes the following stages:

(i) application of the colloidal system onto a substrate; the colloidal system must possess thixotropic properties, which are provided by maintaining a preset temperature and a certain concentration of the dispersed phase;

(ii) conversion of the applied colloidal system into a high flow state by any external action (heating, shear straining, etc.) decreasing viscosity of the solution; this action can be either applied during the whole subsequent alignment stage or last for a minimum necessary time, so that the system would not relax into a state with increased viscosity during orientation.

(iii) external orienting and/or activating action upon the system, which can be produced by at least one of the following methods: application of a hydrophilic coating; rubbing the substrate surface in a certain direction; etching of the substrate surface; deposition of a silicon oxide layer; exposure of a light-sensitive substrate to UV radiation; substrate treatment in a plasma discharge; or by any other known method. The degree of the external action must be sufficient to impart necessary orientation to the kinetic units of the colloidal system and form a structure, which would serve as a base of the crystal lattice of the layer.

(iv) conversion of the oriented region of the layer from the state of reduced viscosity, which was achieved by the initial action, into the state of the initial or higher viscosity; this transition is performed so as not to cause disorientation of the existing structure and not to produce surface defects;

(v) drying stage (solvent removal), in the course of which the crystal structure is formed;

(vi) conversion of the crystal film into a water-insoluble form by treating the surface with a solution containing ions of divalent or trivalent metals (e.g., barium);

(vii) optional stage may consist in introducing surfactants into composition of the applied colloidal system, which increases the film adhesion to substrate.

In the resulting crystal film, the molecular planes are parallel to each other and the molecules form a three-dimensional crystal structure. The optical axis of the crystal film is perpendicular to the molecular plane. Such films are highly anisotropic and exhibit a high refractive index and/or high absorption coefficient in at least one direction. A distinctive feature of these crystal films is the high thermal stability, which is especially important for the modern LCD production technology.

### REFERENCES

1. M. M. Zwick, J. Appl. Polym. Sci., 9, 2393-2424 (1965).

2. Y. Bobrov, A. Grodsky, L. Ignatov, A. Krivostchepov, V. Nazarov, S. Remizov, “Thin Film Polarizers for Liquid Crystal Displays”. Proceeding of SPIE, 2001, Vol. 4511, 133-140.

3. Claussen; U.S. Pat. No. 5,340,504.

4. Giichi et al.; JP 5-9145255.

5. Khan et al. PCT WO 94/28073, 1994.

6. Ignatov et al.; PCT WO 00/25155, 2000.

7. P. Yeh and C. Gu, Optics of Liquid Crystal Displays, Wiley, New York (1999).

8. P. Yeh, M. Paukshto “Molecular crystalline thin-film E-polarizer” (2001). Molecular Materials, 14 (1), 1-19.

9. P. Lazarev, and M. Paukshto, “Thin Crystal Film Retarders”. Proceeding of the 7th International Display Workshops, Materials and Components, Kobe, Japan, Nov. 29-Dec. 1, 2000, 1159-1160.

What is claimed is:

1. An optical anisotropic film, comprising at least one anisotropic crystalline layer, representing a substance whose molecules contain aromatic rings and form a lattice with an interplanar spacing of 3.4±0.3 Å along one of the optical axes; and at least one transparent layer
wherein each refractive index n satisfies the condition 2n²<nₒ²+nₑ² where nₒ and nₑ are the refractive indices of the crystalline film for the ordinary and extraordinary rays, respectively.

2. The optical anisotropic film according to claim 1, wherein the transparent layer serves as a substrate.

3. The optical anisotropic film according to claim 2, wherein the substrate surface on the side of the crystalline layer is rendered hydrophilic.

4. The optical anisotropic film according to claim 2, wherein the substrate surface on the side of the crystalline layer bears a relief.

5. The optical anisotropic film according to claim 2, wherein the substrate surface on the side of the crystalline layer is textured.

6. The optical anisotropic film according to claim 2, wherein an additional interlayer is formed between the substrate and the crystalline layer.

7. The optical anisotropic film according to claim 6, wherein the surface of the interlayer facing the crystalline layer is hydrophilic.

8. The optical anisotropic film according to claim 6, wherein the surface of the interlayer facing the crystalline layer bears a relief.

9. The optical anisotropic film according to claim 6, wherein the surface of the interlayer facing the crystalline layer possesses a texture.

10. The optical anisotropic film according to claim 2, wherein the substrate surface is covered with an additional antireflection or antiflashing coating.

11. The optical anisotropic film according to claim 1 or 2, wherein the transparent layer is birefringent.

12. The optical anisotropic film according to claim 2, wherein there is an additional adhesive transparent layer.

13. The optical anisotropic film according to claim 1, wherein the transparent layer serves as an adhesive layer, and the substrate serves as a specular or diffusive reflector.

14. The optical anisotropic film according to claim 13, wherein there is a planarization layer between the substrate and the crystalline layer.

15. The optical anisotropic film according to claim 1, wherein the substrate is a specular or diffusive transflector.

16. The optical anisotropic film according to claim 15, wherein there is a planarization layer between the substrate and the crystalline layer.

17. The optical anisotropic film according to claim 1 wherein the substrate is as a reflective polarizer.

18. The optical anisotropic film according to claim 1, wherein the crystalline film substance contains heterocycles.

19. The optical anisotropic film according to claim 1, wherein the crystalline film comprising at least one organic substance, the chemical formula of which comprises at least one ionogenic group ensuring solubility in polar solvents for obtaining a lyotropic liquid-crystalline phase, at least one counterion, which is either retained or not in the molecular structure in the course of the crystal film formation, and/or at least one nonionogenic group ensuring solubility in nonpolar solvents for obtaining a lyotropic liquid-crystalline phase.

20. The optical anisotropic film according to claim 1, wherein the components of imaginary (K₁, K₂, K₃) and real (n₁, n₂, n₃) parts of the complex refractive index of the crystalline layer obeying the relations K₁≧K₂>K₃ and (n₁+n₂)/2>n₃.

21. The optical anisotropic film according to claim 2, comprising at least one additional adhesive layer.

22. The optical anisotropic film according to claim 21, wherein a protective coating is formed on at least one adhesive layer.

23. The optical anisotropic film according to claim 21, whereby the transmission coefficients of the substrate and/or adhesive layer does not exceed 2% at any wavelength in the 100-400 nm range.

24. The optical anisotropic film according to any of claims 1 to 23, whereby the crystalline layer represents a polarizer of the E type.

25. The optical anisotropic film according to claim 24, whereby the crystalline layer simultaneously represents a polarizer and a phase-shifting layer.

26. The optical anisotropic film according to claim 24, whereby the substrate is made of a polymer.

27. The optical anisotropic film according to claim 24, whereby the substrate is made of a glass.

28. The optical anisotropic film according to claim 24, whereby the substrate transmission in the visible range is not less than 90%.

29. The optical anisotropic film according to claim 24, containing an additional layer the transmission coefficients of which does not exceed 2% at any wavelength in the 100-400 nm range.
